(19) United States
(12) Patent Application Publication
(10) Pub. No.: US 2004/0036196 A1
(43) Pub. Date: Feb. 26, 2004

(54) Powder-free nitrile gloves

(75) Inventor: William E. Conley, Alpharetta, GA (US)

Correspondence Address: Christina L. Mangelsen - Patent Agent, Dority & Manning, Attorneys at Law, P.A., P.O. Box 1449, Greenville, SC, 29602, US

(73) Assignee: Kimberly-Clark Worldwide, Inc.

(21) Appl. No.: 10/224,620

(22) Filed: Aug. 20, 2002

(51) Int. Cl. B28B 1/38

(52) U.S. Cl. 264/307

(57) ABSTRACT

The present invention discloses a method of removing a rubber article from a former and producing a powder-free nitrile rubber article without the necessity of any post-stripping powder removal techniques. The process includes contacting a former with a powder-free coagulant composition and then contacting the former with a nitrile latex emulsion to form the matrix of the article on the former. The latex is then cured to form the rubber article on the former. After the rubber article is cured, the article is contacted with a bath, such as a hot water bath. The bath causes the nitrile rubber film to swell and break free of the former. The article may then be dried, cooled, and easily stripped from the former. In one embodiment, the powder-free rubber articles may be stripped and immediately packed for distribution with no further processing of the articles required.

### BACKGROUND OF THE INVENTION

Nitrile rubber articles formed from nitrile latex emulsions have been used in the past in many different applications including surgeons gloves, examining gloves, prophylactics, catheters, balloons, tubing, and the like. Nitrile latex has been useful in the production of such articles in part because of its physical properties upon curing. For example, nitrile rubber may exhibit very elastic properties. The articles formed not only may be stretched many times their length, but are also capable of substantially returning to their original shape when released. In addition, nitrile rubber articles may exhibit high strength and prove to be impermeable to many solvents and oils.

Traditionally, nitrile rubber articles have been manufactured through the use of a mold or former in the shape of the article to be produced. For example, when manufacturing a glove, a hand-shaped mold or former is first dipped in a coagulant slurry. After the slurry has dried on the former, the former is dipped in a nitrile latex such that a coating is coagulated on the former. The latex is then cured and the formed nitrile rubber article may be stripped from the mold, which may also invert the glove.

One problem encountered with nitrile rubber articles in the past is that they may adhere very tightly to the formers during the curing process. This may cause difficulties during production including, for example, tearing of the gloves as the product is stripped from the formers. As a result of such problems, processes have been developed to more easily strip the products from the formers during production of the gloves.

Historically, the most common process for improving stripping ability has been the addition of a powder such as calcium carbonate to the coagulant slurry used when forming the glove. The powder acts as a buffer or barrier between the former and the glove film to help in preventing the film from adhering to the former during the curing process. A certain amount of this powder, however, may remain on the surface of the glove after it has been stripped from the former. While powder on the glove surface is acceptable for some applications, powders may not be desired in certain applications, such as surgical or other clean-room type applications.

As a result, post-stripping powder-removal processing techniques have been developed. For example tumbling and other methods for physical removal of powder as well as chemical surface treatments such as chlorination have been developed in order to eliminate powders on the product after it has been stripped from the former. However, these powder-removal techniques tend to not only be expensive, but also require the additional post-stripping processing of the product prior to packaging and shipment.

Thus, a need exists for a method of producing a powder-free nitrile rubber article which may be easily stripped from the forming mold and requires no post-stripping powder removal techniques such as those known in the past.

### SUMMARY OF THE INVENTION

The process of the present invention is directed to the production of nitrile rubber articles. In one embodiment, the process of the present invention is directed to a method of removing a nitrile rubber article from a former. Through the processes of the present invention, powder-free articles may be produced which do not require any post-stripping powder removal techniques.

In general, the method of the present invention is directed to a process in which a former or mold is used to form a nitrile rubber article. For example, the former may be a hand-shaped former and may be used to form a nitrile glove. In forming a glove, the former may be dipped into a coagulant slurry. In one embodiment, the coagulant slurry may be a powder-free coagulant slurry and the process may thus be used to produce powder-free nitrile gloves. After the coagulant has been applied and dried on the former, the former may be contacted with a nitrile latex emulsion which may coagulate on the former and form the primary matrix of the glove. The nitrile film may then be cured to form the nitrile rubber article on the former and subjected to a bath in a polar liquid.

If desired, the article may be additionally processed prior to the bath of the present invention. For example, prior to curing, the latex layer may be leached with water to remove impurities. The article may also be subjected to an overdip process to form one or more additional polymer layers on the latex layer prior to final curing. In the case of a glove, an additional layer may be a donning layer or a gripping layer. After curing, if desired, the article may be subjected to further processing, such as a halogenation process. Such a process may, for example, decrease the surface tackiness of the rubber article.

Once cured, the nitrile rubber article may be immersed in a bath of a liquid which exhibits a polarity, such as water, prior to stripping the article from the former. In on embodiment, the bath may be at a temperature greater than about 150° F. In another embodiment, the bath may be at a temperature greater than about 180° F. In still another emeodiment, the bath may be at a temperature greater than about 190° F. The bath may cause the cured nitrile film to swell and break free from the former. For example, a water bath may be at a temperature between about 180° F. and about 212° F.

The dwell time of the article in the bath may depend on the bath temperature and the characteristics of the glove, such as glove wall thickness. Generally, the bath dwell time may be less than about 1 minute. For instance, the dwell time may be less than 30 seconds. In one embodiment, the dwell time may be between about 10 seconds and about 12 seconds.

After the bath of the present invention, the article may be stripped from the former. In one embodiment, the glove may be dried prior to stripping, as in a convective oven, cooled, and then stripped from the former. For example, the article on the former may be dried at a temperature between about 250° F. and about 275° F. for a period of less than about three minutes. In one embodiment, the article may be dried in an oven for less than about one minute.

After removal from the former, the glove may be further processed as desired prior to packaging. For example, the glove may be dried after the stripping process rather than before. In one embodiment, the glove may be packaged immediately after stripping from the former with no post-stripping processing required.

### BRIEF DESCRIPTION OF THE FIGURES

A full and enabling disclosure of the present invention, including the best mode thereof to one of ordinary skill in the art, is set forth more particularly in the remainder of the specification, including reference to the accompanying figures in which:

FIG. 1 is an illustration of glove-shaped formers that may be used in accordance with one embodiment of the present invention; and

FIG. 2 is a front view of a glove according to the present invention.

### DETAILED DESCRIPTION OF THE INVENTION

It is to be understood by one of ordinary skill in the art that the present discussion is a description of exemplary embodiments only, and is not intended as limiting the broader aspects of the present invention, which broader aspects are embodied in the exemplary construction.

The present invention is generally directed to but not limited to the production of powder-free nitrile rubber articles having good stripping characteristics. More specifically, the nitrile rubber articles of the present invention may be powder-free nitrile rubber articles which may be easily stripped from the forming molds and which do not require any additional post-stripping powder removal processing techniques, such as, for example, chemical surface treatments. In addition, the processes of the present invention may help clean the surface of the rubber article. Though the nitrile rubber articles referred to in the remainder of this description are generally referred to as gloves, it should be understood that the present invention is applicable to other nitrile rubber articles as well, and is not to be limited to gloves.

In general, the method of the present invention is directed to a process in which a former or mold is used to form a nitrile rubber article. For example, the former may be a hand-shaped former and may be used to form a nitrile glove. In forming the glove, the former may be dipped into a coagulant slurry, for example a powder-free coagulant slurry. After the coagulant has been applied and dried on the former, the former may be contacted with a nitrile latex emulsion which may coagulate on the former and form the primary matrix of the glove. After any additional desired pre-stripping processing steps, and after the nitrile film is cured but prior to stripping the glove from the former, the former may be immersed in a bath for a period of time. In one embodiment, the bath may be a water bath. During the water bath, it is believed the nitrile rubber film may swell and break away from the surface of the former. If desired, the glove may then be dried, cooled, and may be easily stripped from the former. The process may thus produce powder-free nitrile gloves without the need of any post-stripping powder removal processes.

In an alternative embodiment, however, a powder may be included with the coagulant slurry for use in conjunction with the present invention to remove gloves from a former. In this embodiment, however, depending upon the particular application, a post-stripping powder removal process, such as a rinsing process, may be required in those embodiments requiring a powder-free glove.

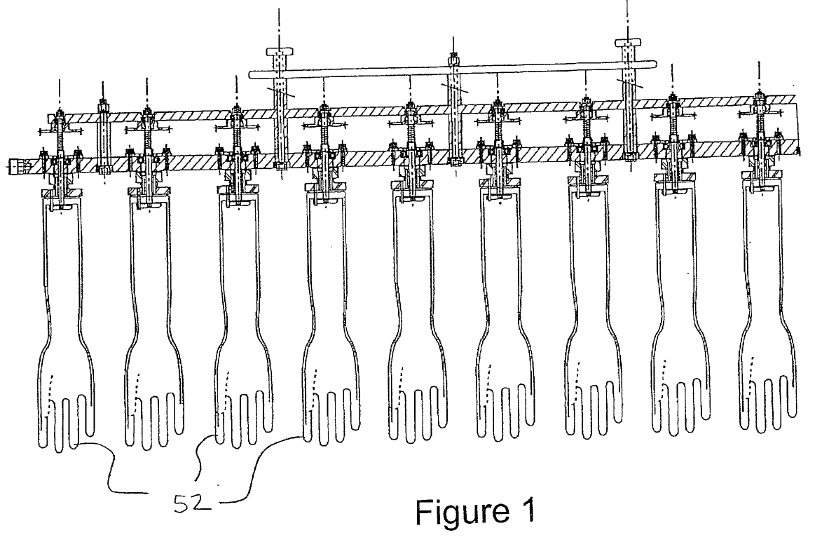

FIG. 1 is an illustration of a series of glove molds or formers 52 which may be used to form the nitrile rubber gloves of the present invention. The formers 52 shown in FIG. 1 are illustrated on a pallet as is conventionally used in a batch processing operation, but it should be understood that the process of the present invention may equally be utilized in a continuous operation. A former 52 may be generally recognized as a contoured mold having a textured or smooth surface which may accept a series of coatings and release the formed glove. Possible materials for the surface of former 52 may include any suitable surface material. For example, the surface of former 52 may be formed of ceramic, porcelain, glass, metal, or certain fluorocarbons.

If desired, a former 52 may be cleaned prior to formation of a glove on the former. The cleaning process may generally include an optional water pre-rinse followed by an acid wash. After the acid wash, the former 52 may be rinsed with water and dipped in a heated caustic solution prior to a final rinse. After the optional cleaning process, a glove may be formed on the former 52 through a series of dipping and drying steps.

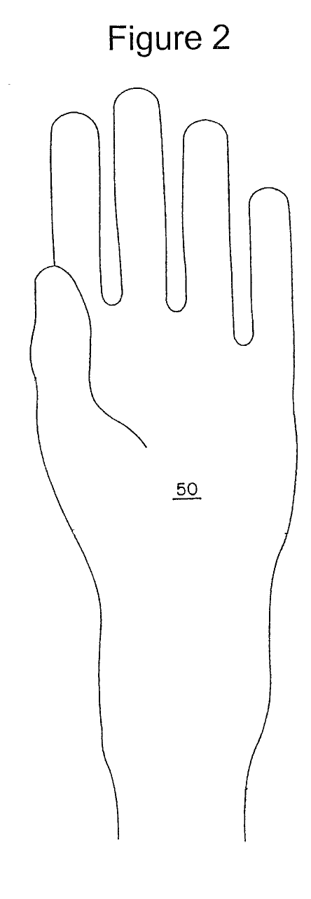

FIG. 2 illustrates one possible embodiment of a product made in accordance with the present invention which in this case is a glove 50 which may be formed on former 52. The glove 50 may be powder-free and still be easily stripped from the former and have good tactile characteristics. In one embodiment, the glove 50 may be formed through a series of dippings or immersions of the former 52. For example, in one embodiment, after cleaning, the former 52 may be dipped into a powder-free coagulant composition.

In general, a coagulant causes the base polymer which will form the body of the glove to coagulate and polymerize. Coagulants that may be used in the present invention may include a solution of a coagulant salt such as a metal salt. Examples of coagulants may include but are not limited to water soluble salts of calcium, zinc, aluminum, and the like. For example, in one embodiment, calcium nitrate in water or alcohol may be used in the coagulant composition. In some embodiments, calcium nitrate may be present in the solution in an amount of up to about 40% by weight although a greater or lesser amount may also be used. Optionally, the coagulant composition may also contain additives such as surfactants. In one embodiment, the coagulant composition may include the following:

| | |
|---|---|
| Calcium nitrate (77%) | 18.75 wt % |
| SURFYNOL TG (non-ionic surfactant) | 0.15 wt % |
| Teric 320 (10%) (non-ionic surfactant) | 1.37 wt % |
| SURFONYL DF 37 (non-ionic surfactant) | 0.005 wt % |
| Water | remainder |

After being immersed in the coagulant composition, the former 52 may be withdrawn and the coagulant present on the surface of the former may be allowed to dry. For many applications, the coagulant may be air dried for a time of from about one minute to about two minutes. Once dried, a residual coating of the coagulant is left on the former.

If desired, the coagulant composition may optionally contain certain additives. For example, the coagulant composition may contain various additives which may improve the tactile characteristics of a surface of the glove. Alternatively, the coagulant composition may contain certain release aids which, when combined with the processes of the present invention, may further improve the stripping ability of the glove. In any case, coagulant composition additives should not hinder the processes of the present invention.

After the coagulant dip, the former may be immersed or dipped into a nitrile latex emulsion. In general, the latex emulsion of the present invention may have a latex content of less than about 50% although greater amounts are possible. In one embodiment, the latex emulsion may have a latex content of less than about 25%. The latex emulsion may also contain various additives such as pH adjustors, stabilizers, and the like as are generally known in the art. Upon contact of the latex with the coagulant composition, the coagulant may cause some of the nitrile latex to become locally unstable and coagulate on the surface of the former. In many applications the coagulant itself does not form a separate layer of the final glove, but rather becomes a part of the nitrile film forming the primary matrix of the glove. Any additives in the coagulant composition may, depending upon what they are, remain between the former and the nitrile film, or alternatively may be incorporated into the nitrile film. After the desired amount of time, the former 52 is withdrawn from the latex emulsion, and the coagulated nitrile layer is allowed to coalesce fully on the former.

The amount of time the former 52 is immersed (commonly termed as dwell time) in the nitrile latex emulsion determines the thickness of the film. Increasing the dwell time of the former in the latex causes the thickness of the film to increase. The total thickness of the film forming the glove body may depend on other parameters as well, including, for example, the solids content of the latex emulsion and the additive content of the latex emulsion and/or the coagulant composition.

Once the former 52 is removed from the nitrile latex emulsion and prior to curing the latex, the primary matrix of the glove now present on the former may be further processed, as desired. Various pre-cure processing techniques are generally known in the art. For example, the nitrile emulsion layer may be gelled with heat to strengthen the elastomeric rubber film. If desired, the uncured latex layer may be leached with flowing hot water. A leaching process may extract various emulsion constituents, such as salts and water, for example, from the coalesced latex. This may cause the latex emulsion to shrink somewhat on the former and remove impurities from the coalesced emulsion.

Another possible process prior to the final cure of the glove may involve the formation of additional polymer layers on the primary matrix and is generally termed an over-dip process. This is generally done by immersing the former into an emulsion of the desired polymer. Additional layers on the primary matrix may form desired donning or gripping layers on the glove which may, for instance reduce the tackiness on the surface of the glove. These post processes may be done individually or in any combination.

For instance, nitrile rubber, once cured, may, in some applications, have a tacky, or sticky, surface. A tacky glove surface may cause various difficulties for consumers. For example, a tacky donning surface may make it difficult to put the glove on, and a tacky gripping surface may cause the gloves to stick together during packaging. As such, various processes have been developed for decreasing the tack on the surface of such articles. One such process includes the formation of another polymer layer on the surface of the primary matrix of the glove prior to curing the latex.

In one embodiment of the present invention, what will eventually be an inner donning layer may be formed on the glove after the primary matrix of the glove has been coalesced on the former. Possible donning layers may be formed of any suitable material and are generally known in the art. For example, possible donning layers may include but are not limited to a polyurethane coating, a silicone coating, a polybutadiene coating, or a hydrogel coating.

Alternatively, a subsequent layer may be formed on the primary matrix of the glove which may be utilized as a gripping layer in the final product. In this case, of course, after stripping the glove from the former, which will cause the glove to be turned inside out, the glove will be again reversed, such that the gripping layer is on the exterior of the glove. Possible gripping layers are well known in the art and include, for example, a polymer coating made from an elastomer.

After the nitrile latex dip and any subsequent desired processing and/or overdips, the nitrile latex layer coalesced on the former may be cured, or vulcanized, to form a nitrile rubber film. In general, the latex is cured by high temperature reaction with a vulcanizing agent, such as sulfur, to cause cross-linking of the polymer chains. Curing may generally take place at temperatures of between about 200° F. and about 300° F. In addition to curing the latex, the high temperature process may cause the evaporation of any volatile components remaining on the former, including any water remaining in the emulsion. Therefore, the curing process may cause shrinkage in the film and the thickness of the cured rubber film may generally be less than the thickness of the latex emulsion which was coalesced on the former. In general, the thickness of a glove wall formed by the processes of the present invention may be anywhere from about 3 mil to about 15 mil. For instance, in one embodiment, the glove thickness is from about 3 mil to about 5.5 mil. In addition to vulcanizing the latex to form the cross-linked rubber film, the curing process may also cause the rubber to adhere tightly to the former.

After the rubber has been cured, and prior to the hot bath of the present invention, additional processing steps may be desired. For example, if desired, the surface of the glove may be chemically treated following curing, such as in a halogenation process. Halogenation processes such as chlorination are known in the art and have been used for various purposes, such as for reducing the tackiness on the surface of a nitrile rubber article. In one embodiment, a halogenation process includes injecting a halogen gas, such as chlorine gas, for example, into water and then dipping the article on the former into the halogenated water. Other known methods of chlorinating the glove can alternatively be used, however.

After the glove is cured and any post-cure processing steps have been completed, the process of the present invention includes subjecting the article to a bath, such as a water bath, prior to stripping the article from the former. Though not bound by any particular theory, it is believed that water, which is polar, acts upon the polar nitrile rubber film, causing it to swell and break loose from the material of the formers to which it adhered during the curing process. As such, it is further believed that other polar solutions which would not prove detrimental to the glove could alternatively be used as the bath solution in place of water. For example, other polar solutions which may be used as the bath solution can include solutions of ketones, amines, and/or alcohols. For instance, an ethanol or methanol solution could be used as the bath solution in place of a water bath.

As previously discussed, in certain embodiments, various possible additives may be included in the coagulant composition which was applied to the former prior to the latex emulsion dip. It is believed that possible additives may include additives which exhibit polarity, as does nitrile rubber.

In general, it is not necessary to include any additives in the bath and the bath may contain, for instance, only water. Therefore, in addition to breaking the rubber film away from the former, the water bath may also help to clean the surface of the glove.

The temperature of the bath is generally warm enough to enable the nitrile film to swell and break loose from the former material in the time the film is immersed in the bath in order that the nitrile rubber glove may later be easily stripped from the former. Higher temperature baths in some applications, may provide various advantages. For instance, the higher the temperature of the bath, the faster a subsequent drying process may be. Also, the gloves have been found to be easier to strip as the temperature of the bath is increased. In one embodiment, the bath temperature may be greater than about 150° F. In one embodiment, the bath temperature may be greater than about 180° F. In another embodiment, the bath temperature may be greater than about 190° F.

In addition to the bath temperature, the amount of time the formers are held in the bath, commonly referred to as dwell time, may affect the ease of stripping the gloves from the formers. Generally, the dwell time should be long enough for the water to swell the nitrile film and break the film loose from the former material. As such, the dwell time may depend on the thickness of the nitrile film, with a thicker film requiring a longer dwell time.

In general, the higher the bath temperature and the longer the dwell time, the easier the subsequent stripping process may be. For example, at the above mentioned temperatures, a dwell time of less than about one minute may allow a glove to be easily stripped from a former. Specifically, a dwell time of less than about 30 seconds may be suitable. In one embodiment, a hot water bath dwell time of about 10 to about 12 seconds may be enough to allow a glove to be easily stripped from a former. Lower temperatures than those specifically mentioned above are possible, but at lower temperatures, a longer dwell time may be preferred in order to promote the desired stripping ability.

After being immersed in the liquid bath, the articles may be easily stripped from the formers. For most applications, the articles may be dried while still on the former prior to stripping. Alternatively, however, in some applications, it may also be possible to strip the articles from the formers while wet and then dry the articles later.

When drying the articles prior to stripping, the articles while still on the formers may be dried by applying heat to the articles. For instance, the articles while on the formers may be contacted with hot air, such as in a convective oven. For example, in one embodiment, the formers may be transferred from the liquid bath to an oven to be dried.

In the oven, convective air at a high temperature may dry the film and remove any residual moisture. For example, convective air at a temperature of between about 250° F. and about 275° F. may be used to dry the formers. In this temperature range, the drying process may be very fast, for example, the gloves may be dried in the oven for about 3 minutes. In one embodiment, the film may be dried in the oven in about one minute. In another embodiment, the film may be dried in the oven for less than about one minute.

In an embodiment wherein the gloves are dried while still on the formers, the gloves may optionally be cooled after the residual moisture is removed and then stripped from the formers. The gloves may be cooled either actively (e.g., subjecting the formers to a cool air stream) or passively, or a combination of both as by merely removal from the oven and cooled for period in ambient air. In one embodiment, the gloves may be cooled to a temperature of less than about 100° F.

By use of the processes of the present invention, the gloves may be easily stripped from the formers without any powder or other barrier layer necessary between the formers and the gloves. Among other benefits, this may eliminate the need for any post-stripping processes prior to packaging the gloves for shipment. For example, powder removal techniques such as tumbling or other post-stripping surface chemical treatments are no longer necessary for production of powder-free nitrile gloves when using the processes of the present invention. In one embodiment, the processes of the present invention may be used to produce powder-free nitrile gloves that may be stripped from the formers and immediately packaged for distribution to consumers with no additional post-stripping processes required at all.

It should be understood, however, that the process of the present invention may also be used in conjunction with powders, such as calcium carbonate or cornstarch, to facilitate stripping.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A process for producing a nitrile rubber article comprising:
contacting a former with a coagulant composition;
contacting said former with a nitrile latex emulsion, said nitrile latex coagulating on said former to form a coalesced nitrile latex layer on said former;
curing said nitrile latex to form a nitrile rubber article on said former;
immersing said nitrile rubber article on said former in a bath, said bath comprising a liquid which exhibits a polarity, said bath being at a temperature and said nitrile rubber article being immersed in the bath at said temperature for a time sufficient for the article to swell; and
stripping said nitrile rubber article off of said former.

2. The process of claim 1, wherein said coagulant composition is a powder-free coagulant composition.

3. The process of claim 1, wherein said nitrile rubber article is a glove.

4. The process of claim 1, further comprising forming a polymer layer on said coalesced nitrile latex layer.

5. The process of claim 1, further comprising chlorinating said rubber article.

6. The process of claim 1, wherein said bath is at a temperature greater than about 150° F.

7. The process of claim 1, wherein said bath is at a temperature greater than about 180° F.

8 The process of claim 1, wherein said bath is at a temperature greater than about 190° F.

9. The process of claim 1, wherein said liquid is water.

10. The process of claim 9, wherein said water bath is at a temperature between about 180° F. and the boiling temperature of the bath.

11. The process of claim 10, wherein said nitrile rubber article is immersed in said bath for between about 10 and about 12 seconds.

12. The process of claim 1, wherein said nitrile rubber article is immersed in said bath for less than about 1 minute.

13. The process of claim 1, wherein said nitrile rubber article is immersed in said bath for less than about 30 seconds.

14. The process of claim 1, further comprising drying said article prior to stripping said article from said former.

15. The process of claim 14, wherein said nitrile rubber article is dried in an oven.

16. The process of claim 15 wherein said nitrile rubber article is dried in said oven for less than about three minutes.

17. The process of claim 15, wherein said nitrile rubber article is dried in said oven for less than about one minute.

18. The process of claim 14, further comprising cooling said nitrile rubber article after said drying.

19. The process of claim 1, wherein said nitrile latex is cured at a temperature of between about 200° F. and about 300° F.

20. A process for removing a glove from a former comprising:
forming a glove on a former, said glove being made from a nitrile polymer;
immersing the glove on said former in a water bath at a temperature and for a time sufficient for the glove to swell; and
stripping said glove off of said former.

21. The process of claim 20, wherein said glove comprises more than one polymer layer.

22. The process of claim 21, wherein one polymer layer is a donning layer.

23. The process of claim 20, wherein the glove is immersed in the water bath for less than about 30 seconds.

24. The process of claim 20, wherein the water bath is between about 180° F. and about 212° F.

25. The process of claim 24, wherein the glove is immersed in the water bath for between about 10 and about 12 seconds.

26. The process of claim 20, wherein the water bath consists essentially of water.

27. The process of claim 20, wherein the glove is a powder-free glove.

28. A process for producing a powder-free nitrile rubber article comprising:
contacting a former with a powder-free coagulant composition;
contacting said former with a nitrile latex emulsion, said nitrile latex coagulating on said former to form a coalesced nitrile latex layer on said former;
curing said nitrile latex to form a nitrile rubber article on said former;
immersing said nitrile rubber article on said former in a water bath, said bath being at a temperature of between about 150° F. and about 212° F., said nitrile rubber article being immersed in the bath for a time sufficient for the article to swell;
drying said article;
cooling said article; and
stripping said article off of said former.

29. The process of claim 28, wherein said nitrile rubber article is a glove.

30. The process of claim 28, further comprising forming a polymer layer on said coalesced nitrile latex layer.

31. The process of claim 28, further comprising chlorinating said rubber article prior to immersing said article in the bath.

32. The process of claim 28, wherein the bath is at a temperature between about 180° F. and about 212° F.

33. The process of claim 28, wherein said bath is at temperature between about 190° F. and about 212° F.

34. The process of claim 33, wherein said nitrile rubber article is immersed in said bath for between about 10 and about 12 seconds.

35. The process of claim 28, wherein said nitrile rubber article is immersed in said bath for less than about 1 minute.

36. The process of claim 28, wherein said nitrile rubber article is immersed in said bath for less than about 30 seconds.

37. The process of claim 28 wherein said nitrile rubber article is dried in a convective oven for less than about three minutes.

38. The process of claim 37, wherein said nitrile rubber article is dried in said oven for less than about one minute.
